(19) United States
(12) Patent Application Publication
(10) Pub. No.: US 2021/0133017 A1
(43) Pub. Date: May 6, 2021

(54) APPROACH TO PREDICTING ENTITY FAILURES THROUGH DECISION TREE MODELING

(71) Applicant: NEC Laboratories America, Inc., Princeton, NJ (US)

(72) Inventors: Wei Cheng, Princeton Junction, NJ (US); Shuchu Han, Princeton Junction, NJ (US); Haifeng Chen, West Windsor, NJ (US)

(21) Appl. No.: 17/075,309

(22) Filed: Oct. 20, 2020

Related U.S. Application Data
(60) Provisional application No. 62/927,759, filed on Oct. 30, 2019.

(51) Int. Cl. G06F 11/07; G06F 16/22; G06N 20/00

(52) U.S. Cl. CPC G06F 11/0757; G06F 11/0709; G06N 20/00; G06F 16/2246; G06F 11/0778

(57) ABSTRACT

Systems and methods for predicting device failure, including inputting a plurality of records for electronic communication devices, each including one or more attributes and a label, as a table to a modeling algorithm, wherein there are separate tables for each period in a time sequence; building a multi-stage decision tree from the time sequence of records using the modeling algorithm running on a processor device; inputting a record for a device having an empty label value into the decision tree to determine the likelihood of entity failure; and reporting a predicted failure for the device to a user on a display to initiate replacement before a next time period.

### RELATED APPLICATION INFORMATION

This application claims priority to Provisional Application No. 62/927,759, filed on Oct. 30, 2019, incorporated herein by reference in its entirety.

### BACKGROUND

### Technical Field

The present invention relates to predicting entity failure from accumulated performance data and more particularly to construction of decision trees to predict future failure of a device or an entity from accumulated performance data.

### Description of the Related Art

Decision Trees can perform classification tasks. Classification rules can be developed from examples having known results, where the classification rules can be based on attributes of the examples. The classification rules can be implemented in the nodes of the Decision Tree, and the resulting classifications are represented in the leaves of the Decision Tree. The tree can be constructed beginning at the root of the tree and proceeding down to its leaves to provide Top-Down Induction of Decision Trees (TDIDT).

### SUMMARY

According to an aspect of the present invention, a computer implemented method is provided for predicting device failure. The computer implemented method includes inputting a plurality of records for electronic communication devices, each including one or more attributes and a label, as a table to a modeling algorithm, wherein there are separate tables for each period in a time sequence. The computer implemented method also includes building a multi-stage decision tree from the time sequence of records using the modeling algorithm running on a processor device. The computer implemented method also includes inputting a record for a device having an empty label value into the decision tree to determine the likelihood of entity failure, and reporting a predicted failure for the device to a user on a display to initiate replacement before a next time period.

According to another aspect of the present invention, a system is provided for predicting device failure. The system includes at least one processor device, and computer memory. The system also includes a modeler configured to receive, as input to a modeling algorithm, a plurality of records for electronic communication devices, each including one or more attributes and a label, as a table to a modeling algorithm, wherein there are separate tables for each period in a time sequence. The system also includes a decision tree builder configured to build a multi-stage decision tree from the time sequence of records using the modeling algorithm running on the at least one processor device. The system also includes a tester configured to receive as input a record for a device having an empty label value into the decision tree to determine the likelihood of entity failure. The system also includes a reporter configured to report a predicted failure for the device to a user on a display to initiate replacement before a next time period.

According to another aspect of the present invention, a non-transitory computer readable storage medium comprising a computer readable program for predicting device failure is provided. The computer readable program includes inputting a plurality of records for electronic communication devices, each including one or more attributes and a label, as a table to a modeling algorithm, wherein there are separate tables for each period in a time sequence; building a multi-stage decision tree from the time sequence of records using the modeling algorithm running on a processor device; inputting a record for a device having an empty label value into the decision tree to determine the likelihood of entity failure; and reporting a predicted failure for the device to a user on a display to initiate replacement before a next time period.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for generating and utilizing a decision tree from data, in accordance with an embodiment of the present invention;

FIG. 2 is a block/flow diagram illustrating a data tables for a series of time intervals for generating decision tree(s) and for subsequent input, in accordance with an embodiment of the present invention;

FIG. 3 illustrates data tables produced by generating ratios for numerical attributes from consecutive periods in a data set, such that new data values are generated from the available data illustrated by the tables in FIG. 2;

FIG. 4 is a block/flow diagram illustrating a decision tree having decision/test nodes and leaf nodes generated from a data table for a first time interval, in accordance with an embodiment of the present invention;

FIG. 5 is a block/flow diagram illustrating a sequence of decision trees generated from data tables for each of the time intervals, in accordance with an embodiment of the present invention;

FIG. 6 is a block/flow diagram illustrating a non-limiting exemplary embodiment for a method of determining the probability for a business entity failing, in accordance with an embodiment of the present invention;

FIG. 7 is a block/flow diagram illustrating a non-limiting exemplary embodiment for a method of determining the probability for a communication or network device failing, in accordance with an embodiment of the present invention;

FIG. 8 is an exemplary processing system 800 to which the present methods and systems may be applied, in accordance with an embodiment of the present invention;

FIG. 9 is an exemplary processing system 900 configured to implement a multi-stage decision tree, in accordance with an embodiment of the present invention; and

FIG. 10 is a diagram of a network including electronic communication devices, in accordance with an embodiment of the present invention.

### DETAILED DESCRIPTION OF PREFERRED EMBODIMENTS

According to an aspect of the present invention, a method/system is provided for extracting transition rules for interpretable prediction that covers evolution of both categorical and numerical features over multiple time snapshots.

In accordance with embodiments of the present invention, systems and methods are provided to/for extract(ing) explicit transition rules that lead to company or device failure, and building a decision tree model that encompasses these transition rules. In various embodiments, transition patterns to failure with conditional probability for enabling companies to advise their customers to avoid failure can be provided. Companies should advise their costumers about possible failure in advance, but also need to explain why and how such failure may occur. The explicit transition rules that give birth to company failure can provide such explanations. Transition rules from transition patterns that predict device failure can be generated and reported to a user to initiate replacement of the failing device before complete failure.

In accordance with embodiments of the present invention, a multi-stage decision tree algorithm is provided, that can implement examples including attribute data in a time series. In various embodiments, the multi-stage decision tree algorithm is provided as a top down induction of decision trees (TDIDT). The induction task develops a classification rule (also referred to as a transition or decision rule) that can determine the class of any object (i.e., example, entity) from the object's values for the attributes, where the values can be over a sequence of time points that can have fixed intervals. A top down induction of a decision tree begins at a root node and proceeds downward, ordered based on the information gain for each test node.

In various embodiments, the attributes may be selected from a defined set of values (e.g., nominal values), may be unrestricted integer values, or may be continuous (real) values. Nominal values for an attribute can be discrete and mutually exclusive, for example, months of the year (e.g., January, December, April, July, etc.).

In one or more embodiments, feature records for n consecutive time periods or intervals (e.g., years), and one label to characterize the outcome of each instance, success or failure, are provided as model-training sets and/or test sets. The variable “n” is an index or hyper-parameter that identifies or defines the time steps for analyzing a transition pattern, for example, n=3 time periods can be=3 years, where n=1 can identify the first year of the 3 years.

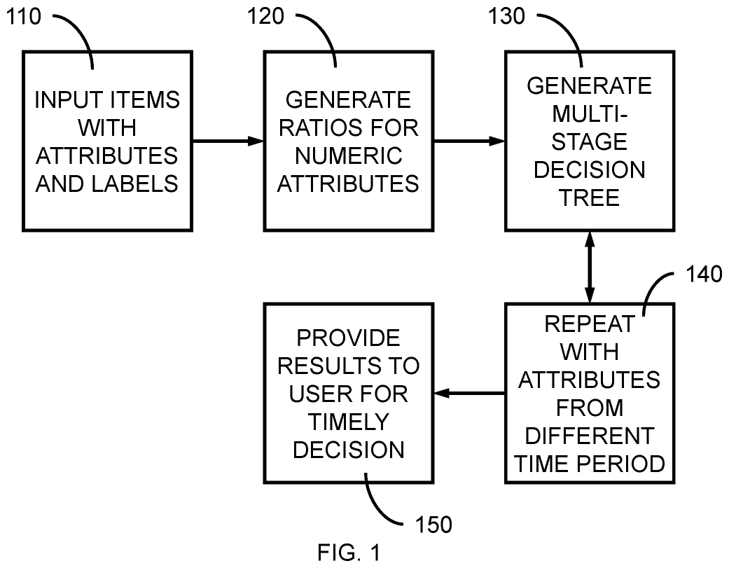

Referring now in detail to the figures in which like numerals represent the same or similar elements and initially to FIG. 1, a block/flow diagram illustrating a high-level system/method for generating and utilizing a decision tree from data is provided, in accordance with an embodiment of the present invention.

At block 110, a set of training data can be input into a model. The training data input can be formatted as a set or sequence of tables, each including the same set of features with values. In various embodiments, the training data can be one or more tables having a plurality of instances that can be training examples or entities (e.g., business entities, communication devices, etc.) with each instance described by two or more attributes and a label to characterize the outcome or condition of that instance. In various embodiments, each training sample equates to a single label. The data and tables can be temporal records for a sequential time interval. In various embodiments, a subset of the training data/samples are used to build the decision tree.

In a non-limiting exemplary embodiment, the training data can be selected from available financial reports for a plurality of business entities extending over at least three years. The training data can be historical financial reports going back several years for both existing and failed (e.g., bankrupt) business entities. The data can thereby be formatted as table 1 for the first year, table 2 for the second year, and table 3 for the third year, where each of the tables include the values of both nominal (categorical) information, such as, company name, company type, and numerical information, such as sales amounts, profits, cash on hand, etc. A decision tree can then be built from the information layer by layer with an algorithm model, for example, layer 1 using table 1, layer 2 using table 2, and layer 3 using table three. Each of the tables can be used to form the decisions nodes for one layer of the decision tree.

At block 120, a new set of tables can be generated from the available data by calculating the ratios of the values for numeric data in a table for a second time interval by the numeric data in a table for a first time interval preceding the second time interval (i.e., numeric data for a table at time n, divided by the numeric data for a table at time n−1, (Tₙ/Tₙ₋₁).

At block 130, a multi-stage decision tree can be generated from one of the available data tables, for example, at times, 1, 2, . . . N−1, N. A first decision tree can be generated from the data table for time 1. The decision tress that are generated can have a predetermined depth, such that a fixed number of layers of test nodes are present in the decision tree, and a fixed number of determinations are made on the data before a leaf of the tree is reached. The attributes and new ratios that generate the greatest information gain can be different at the second or N year, than the first or N−1 year, when generating tests.

At block 140, an additional decision tree can be constructed using a data table at time 2. An additional decision tree can also be constructed using a data table at time 3. This can be repeated for each time, 2, . . . N−1, N, after time 1, to generate N multi-stage decision trees. The decision trees can be implemented as a series of stages, where instances that do not reach a leaf of the tree to get classified can be inputted into a root node of a decision tree at the next stage. Ratio data table can be included in constructing the decision trees and nodes after time 1.

At block 150, the result of the classification of the example or entity (e.g., business (corporation, company, sole proprietorship, etc.), communication device (router, switch, server, etc.) can be presented to a user, for example, on a display in real time, to make a determination. The determination can be whether to provide financial resources to the classified entity based on the probability that the entity will remain a going concern or has a high probability of failure or replacement indicators for a device. The threshold for failure may be determined by the user based on the amount of risk the user is willing to accept.

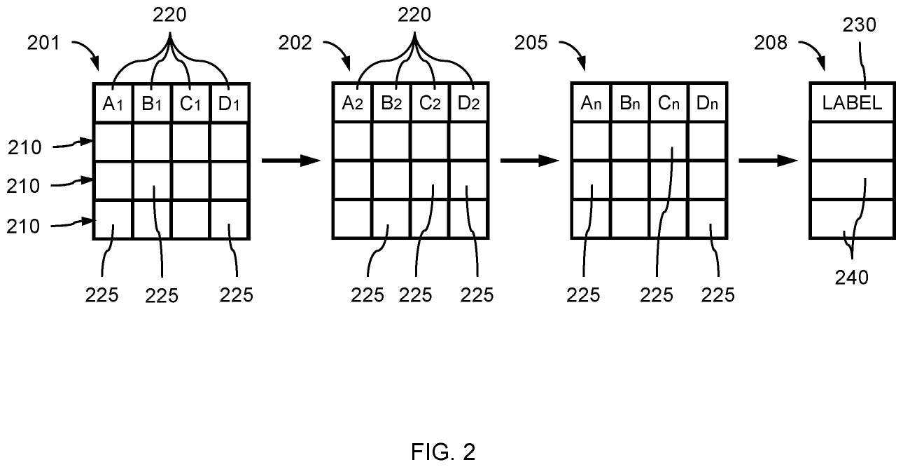

FIG. 2 is a block/flow diagram illustrating a data tables for a series of time intervals for generating decision tree(s) and for subsequent input, in accordance with an embodiment of the present invention;

In various embodiments, a data table 201, 202, 205, can included a plurality of instances 210 that can be entities or examples having one or more attributes 220 (e.g., A, B, C, D, etc.) with values for the attributes that can be placed in cells 225 of the table. The entities or examples 210 can be described in terms of a collection of one or more attributes 220, where each attribute can measure a feature of the entities or examples 210.

In various embodiments, the attributes 220 can take on a range of different values, where those values may be, for example, integers, real numbers, non-numeric qualities, or categories. The attributes can measure different aspects of an entity or example 210 that relate to qualities of interest, for example, financial performance, weather/rain prediction, marketing activities, device performance, etc.

In various embodiments, there can be from 100 to 5,000,000 instances in a training set, or about 100 to about 10,000 instances in a training set, or about 100 to about 1,000 instances in a training set, or about 100,000 to about 5,000,000 instances in a training set, or about 100,000 to about 500,000 instances in a training set, or about 1,000,000 to about 5,000,000 instances in a training set, although other amounts and ranges are also contemplated.

In various embodiments, each instance 210 can be described by from 1 to about 500 attributes, or about 10 to about 250 attributes, or about 20 to about 100 attributes, or about 5 to about 25 attributes, although other amounts and ranges are also contemplated, where each attribute can provide distinct information about an instance 210.

In various embodiments, the numeric attributes can be integers or real numbers that can vary between 1 to 100, for example for business locations, and 50 to 5,000 for sales associates, or can be in the millions or billions, for example, 10,000,000 to 1,500,000,000 for yearly sales depending on the business.

In various embodiments, a set of data tables 201, 202, 205 can represent a time series, T₁, T₂, . . . Tₙ, of the data available for each of the attributes 220 for each of the examples or entities 210. A data table 201, 202, 205 can include values for attributes A, B, C, D, at the particular time, T₁, T₂, . . . Tₙ, where attributes A, B, C, D, at time 1 (i.e., T₁) are identified as A1, B1, C1, D1, etc. In various embodiments, the time series can be for fixed intervals, for example, consecutive days, weeks, months, quarters, years, etc., where each table can include the data available for that time period. In various embodiments, all of the calls of a table may include data, or some cells of a table may be empty or include null values for unknown or unavailable data.

In one or more embodiments, the instances 210 can include a known class or outcome referred to as a label 230 for an identified entity (e.g., business (corporation, company, sole proprietorship, etc.)), which can be in a label table 208. The periodic data tables 201, 202, 205 can arrive at a result, decision, or condition identified by label 230. Each example 210 may have a single outcome that can place the entity in a particular class (e.g., viable or not viable). The time series of data tables 201, 202, 205 can result in a single classification or outcome 240 that is assigned to the particular instance 210. The examples 210 with known classes or outcomes can be used to train and/or test a model, where the model can be a Decision Tree. The label 230 can specify the outcome and the concept being learned by the model. In various embodiments, the concept/outcome can be the continued viability of a business or functioning of a communication device. The viability can be based on one or more financial characteristics of the business.

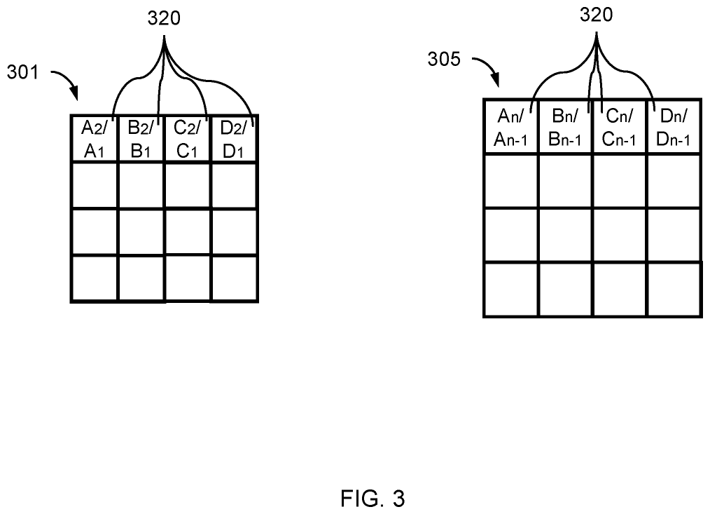

FIG. 3 illustrates data tables produced by generating ratios for numerical attributes from consecutive periods in a data set, such that new data values are generated from the available data illustrated by the tables in FIG. 2.

In one or more embodiments, attribute ratios 320 for numerical attributes can be generated from consecutive periods, T₁, T₂, . . . Tₙ, where, for example, a value of attribute B at time 2 can be divided by the value of attribute B at time 1 to produce the ratio, B₂/B₁. A new ratio data table 301, 305 can be generated for each consecutive pair of attributes for a time n and time n−1 to produce the ratio, Bₙ/Bₙ₋₁. This can be done for multiple attributes to generate a ratio table. Generating ratios for numerical attributes over consecutive periods can provide additional data for testing and decision-making. The values for consecutive ratios may show clearer trends in the data.

In various embodiments, the new ratio data values can be used to generate additional data points for producing additional decision rules (nodes) for a decision tree. The ratio attributes, Bₙ/Bₙ₋₁, and values of those ratios for a table, Bₙ/Bₙ₋₁, can be used as data for generating a decision tree at a level, n. For example, the data for the B₂/B₁ attributes in Table B₂/B₁ can be used to generate decision rules for the decision tree at level 2. In various embodiments, numerical data is used to form the ratio tables; nominal data is not used.

In a non-limiting exemplary embodiment, a ratio of year-to-year sales (e.g., monthly, yearly, year-to-date) can be used to determine if the ratio of sales is increasing at a rate greater than 20% year-to-year. This information and decision test can be evidence of a viable company, whereas an increasing ratio of debt-to-equity year to year can be evidence of a failing company, as indicated by such a trend. The increasing or decreasing measure can be based on the ratio of values as preprocessed.

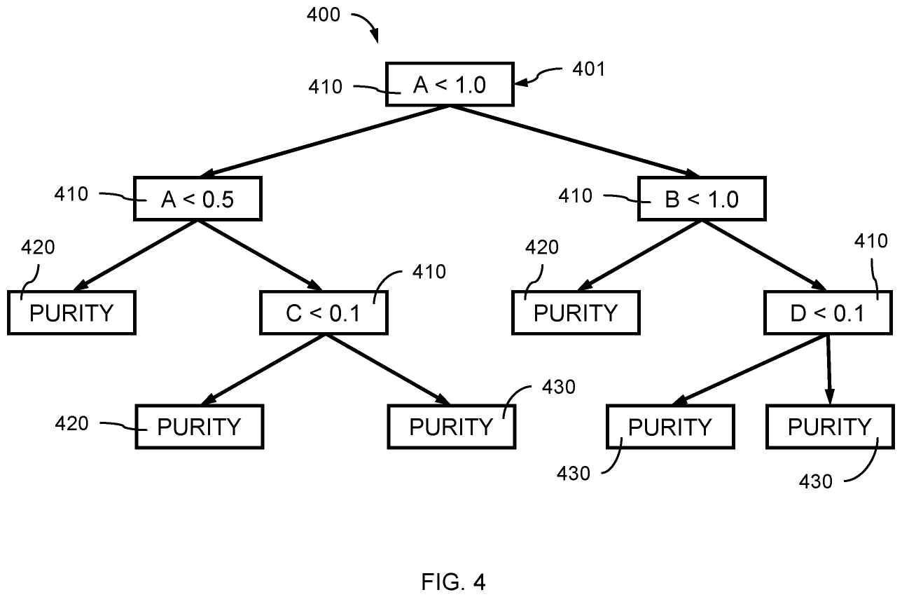

FIG. 4 is a block/flow diagram illustrating a decision tree having decision/test nodes and leaf nodes generated from a data table for a first time interval, in accordance with an embodiment of the present invention.

In one or more embodiments, a set of tests that provide information gain can be determined, where the test/decision providing the greatest information gain based on a first attribute can be implemented as the root node of a decision tree. In various embodiments, each test/decision node can have two paths (branches/results), where one path leads to a leaf node and the second path lead to another test/decision node that provides the next greatest amount of information gain based on an attribute different than the attribute tested at the root or higher layer node. In various embodiments, a different attribute can be tested at each test/decision node.

In various embodiments, a single (i.e., 1) leaf node corresponds to one decision/test node, where the determination at the decision/test node can result in either the one leaf node or another decision/test node. In various embodiments, one leaf node and multiple decision/test nodes can branch off of a single parent node. Each leaf node of the decision tree can also indicate how many test samples (instances) have the outcome indicated by the leaf node, where each instance in the test data that satisfies the decision/test rule arrives at the leaf (i.e., has label 230). The number of instances that arrive at a specific leaf can be termed the “support” for the decision/test. The ratio of the number of sample instances arriving at a specific leaf to the total number of samples in the training data having the same outcome/label 230, can be termed “confidence.” The ratio of each outcome (label 230) to the total number of instances can be calculated to identify the majority outcome (label). Overall, each leaf node can denote one decision rule, and each leaf node is associated with one “support” value and one “confidence” value. The rules with larger “support” and “confidence” values are identified as important and informative rules of the algorithm output.

In one or more embodiments, a data table 201 for a first time period can be used to generate tests for the nodes of the Decision Tree 400. The Decision Tree 400 can be the decision tree for stage (level) 1. In various embodiments, there can be a predetermined number of node layers in the Decision Tree 400 with at least one test node 410 per node layer, where the root node 401 would be layer 1. The decision tree generation can be stopped early to produce the Decision Tree with the predetermined number of node layers and nodes to control the tree depth. In various embodiments, the decision tree generation may be stopped at a node layer where all instances 210 having the majority label (outcome) have been classified, as indicated by reaching a leaf node 420 with a predetermined purity (accuracy) (e.g., 90%, 95%, etc.). Not every decision/test will be 100% accurate, so a predefined accuracy can be chosen. Early stopping of the tree generation can prevent overfitting to the example test data. The Decision Tree 400 generated from the data table 201 for a first time period, T1, can be stage (or level) 1 of a multi-stage decision tree.

In various embodiments, instances 210 (examples or entities) that do not get classified before terminating at a leaf 430 with less than the predetermined purity (e.g., 90%, 95%, 99%, etc.) can then be input into a second stage (level) decision tree generated from a data table 202 for a second time interval, T2, and a ratio data table 301. The data table 202 for a second time interval, T2, and ratio data table 301 can be used for testing (also referred to as “splitting”) the previous stage's instances that did not reach a leaf with the predetermined purity. Splitting refers to additional testing (and branching) of the instances that did not arrive at a high purity (e.g., >90%) leaf node in the higher-level decision tree. Each of the instances 210 that did not reach a high purity leaf node in the higher stage (level) tree can then be further tested at decision nodes in the lower level decision tree (further split). In various embodiments, one time point is used to generate one layer (stage) of the decision tree.

Basic decision tree algorithms, random forest, gradient boosting trees, may only extract the general rules from one time period, so generates a single decision tree from one table.

In various embodiments, the decision tree generation does not involve deep learning or pattern recognition.

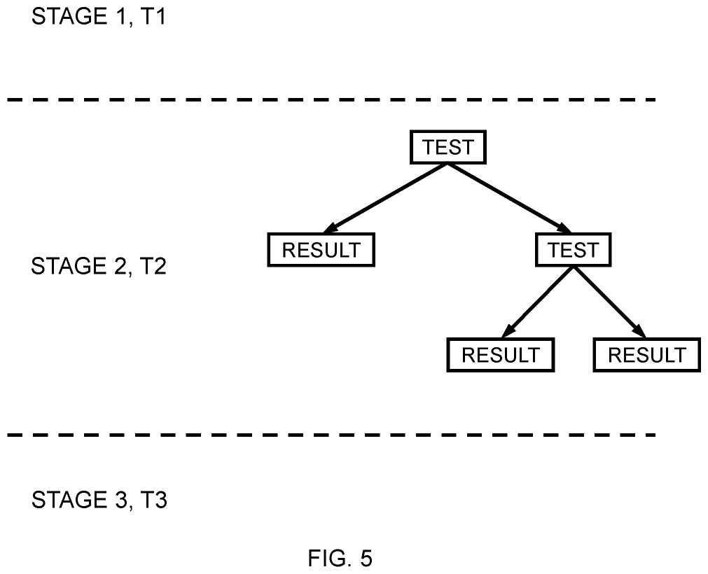

FIG. 5 is a block/flow diagram illustrating a sequence of decision trees generated from data tables for each of the time intervals, in accordance with an embodiment of the present invention.

In one or more embodiments, the Decision Tree generated from data table 201 for time 1, T1, can form Stage 1 of the multi-stage decision tree. The Decision Tree generated from data table 202 for time 2, T2, and the ratio data table 301 can be used to produce Stage 2 of the multi-stage decision tree. Subsequent Decision Trees can be generated from data table 205 for time n, Tₙ, and ratio data table 305 for attribute ratios Aₙ/Aₙ₋₁, to provide an N-Stage decision tree.

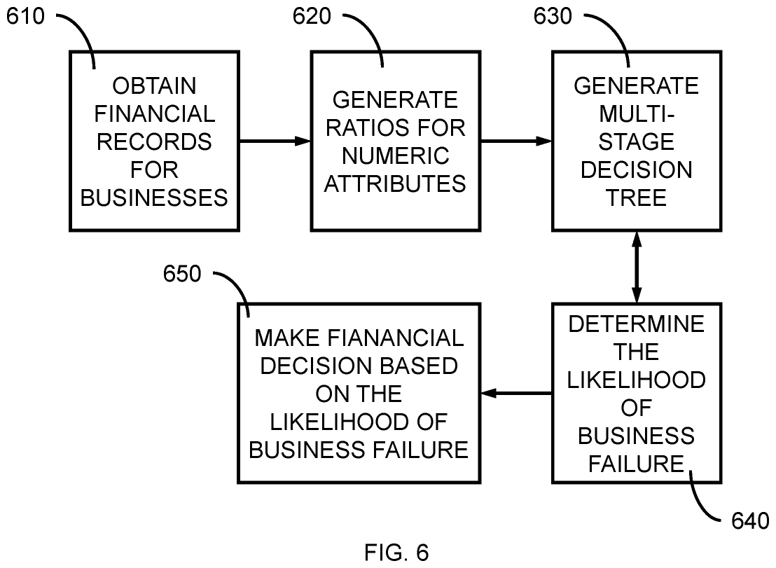

FIG. 6 is a block/flow diagram illustrating a non-limiting exemplary embodiment for a method of determining the probability for a business entity failing, in accordance with an embodiment of the present invention.

At block 610, a set of financial records for a plurality of businesses can be obtained. The financial records can be for a predetermined interval of time, for example quarterly or yearly reports. The financial records can be relevant for making financial decisions at the particular time, and provide sufficient data to evaluate each of the plurality of businesses. The data can include knowledge of whether the business is still in existence as a going concern or has failed at some prior time. A number of attributes that can effectively classify each of the businesses can be selected from the available financial data to produce a set of data tables having a row, R, and column, C, matrix format, R×C.

Each of the entities 210 can be characterized by a set of one or more attributes 220 having known values. A data set in the form of data tables 201, 202, 205 can be a matrix of entities and attribute values, (which can be referred to as a matrix of instances and attributes). A null value can be used for attributes not known or possessed by an entity or instance. The attributes may be numerical (i.e., a numeric value) or categorical (i.e., a class type selected from a specified set (also referred to as nominal or enumerated)). Numeric values may be real numbers, integers, ratios, etc. Class types may identify a non-numeric characteristic, for example, accrual-based accounting, U.S. dollars, non-recurring expense, accounting statement notes, etc. Data for class type attributes may have Boolean values of true or false. Attribute values may be ordered, for example, A>B>C.

In various embodiments, the available data can be preprocessed to be consistent between entities, examples, and/or time periods, so uniform data can be inputted to the model. Data for the same attributes can be preprocessed to have the same units (e.g., U.S. Dollars, Canadian Dollars, Yen, etc.) and/or range of values, which may involve conversion between units and/or normalization or standardization. Normalization and standardization may be used to convert wider ranges of numeric attribute values to a fixed range, for example, 0 to 1. Nominal (categorical) attribute quantities may be converted into numeric values through a distance function, where a value of 1 can indicate that the nominal values are different, and a value of 0 can indicate that the nominal values are the same, for example, corporation=corporation=0; corporation partnership=1. A null value can be used for attributes not known or possessed by an entity or instance.

At block 620, ratios can be calculated for numeric attributes over sequential time periods, for example, liquid assets at time period n divided by liquid assets at time period n−1, or short term debt at time period n divided by short term debt at time period n−1. Separate tables can be constructed using the calculated ratios.

At block 630, a multi-stage decision tree can be generated for classifying the business entities using the data tables previously constructed. A decision tree algorithm can be used to construct a decision tree for a time period using the available data tables and/or constructed ratio tables.

In one or more embodiments, the model for the Decision Trees and multi-stage decision tree can be trained through supervised learning where examples with the actual outcomes identified by experts can be inputted into the model. The tables or matrixes including the attributes for the examples leading to the known results can be inputted into the model. Each instance that provides such input can be characterized by its values on a fixed, predefined set of features or attributes presented in a row of cells in the tables 201, 202, 205. In various embodiments, the decision tree may not be constructed starting with the first available time. Instead the decision tree construction may start with data from a later (e.g., second, third, etc.) time period for the first level decision tree.

In one or more embodiments, the model can be a decision tree having nodes and leaves. The leaves of the Decision Tree can identify the result or class that the entity or example 110 is identified with. In various embodiments, the Decision Tree can have two or more results or classes, for example, pass/fail, succeed/fail, positive/negative, high/middle/low, high/normal/low, top/middle/bottom, etc. The examples/entities can be sorted into one of the two or more results or classes using the Decision Tree.

In one or more embodiments, training the model can involve analyzing an initial set of examples or entities having known outcomes, also referred to as a training set. The model can be trained using supervised learning, where an expert analyzes the examples and generates tests for the model. The tests can be incorporated into nodes of a Decision Tree starting at a root node and progressing through intermediate nodes to leaf nodes that classify the example/entity. The nodes can have a branch for each possible outcome, where the branch appropriate to the test outcome can be taken to the next node or leaf. The example or entity can be assigned to a class identified by the particular leaf. Classification outcomes at the leaves may have a predetermined confidence level. If there are sufficient distinguishing attributes, it is possible to construct a decision tree that can correctly classifies each object in a training set.

In various embodiments, the accuracy of the model can be determined by a success rate on test cases for which the outcome/result is also known, but were not previously used for training. Success of the model may also be measured in terms of how acceptable the rules or decision tree is to a user. The accuracy of the model may be expressed as a purity factor that represents a threshold percent (e.g., 85%, 90%, 95%, 99%, etc.) of test cases determined accurately from a test set of cases.

In one or more embodiments, once the model of the Decision Tree is trained, other objects (e.g., entities) can be correctly classified by applying the attribute tests at the nodes of the Decision Tree.

At block 640, in one or more embodiments, the model learns to predict whether a business is viable or likely to fail as an outcome based on the characteristics of the business. Identifying failure and success patterns from financial data can improve the allocation of limited funds amongst multiple businesses, and avoid the loss of millions of investor and banking institution dollars. Determining whether further investments can save a business or are likely to be wasted and improve the economy as a whole due to productive allocation of funds, as well as improving investor and banking performance.

The decision tree can learn to classify businesses as viable or not viable for making financial decisions, for example, whether a bank should loan money or investors should buy stock or bonds from the entity.

In a non-limiting exemplary embodiment, a company's finances as shown by the company's financial statements (e.g., for the quarter, year, etc.) may indicate two possible conditions, one where the company may remain viable, and another where the failure probability for the coming year becomes much higher. A user could predict the likelihood of the company failing based on the known attributes of the company. The next year, new values for the company may be provided showing any further change in the company's finances. The company's finances as shown by the company's new financial statements can be used to determine whether the likelihood of the company failing has decreased, so that the likelihood of failure is less (the company is safe), or has increased, so the likelihood of failure in the coming time period is much greater. The analysis of the financial statements for successive time periods can show the financial trajectory that the company is on, so banks and investors can determine whether to invest in the company, and at what interest rates and rates of return on their investments.

In a non-limiting exemplary embodiment, for each instance 210, there are feature records for n consecutive years, and one label 240 to characterize the outcome of that instance, as success or failure. “n” can be a hyper-parameter that defines the time steps for considering a transition pattern. A first table 201 can be a set of data for a first year for a set of entities 210 (e.g., companies, businesses), where the data may be available from each of the company's yearly business financial statement(s) (e.g., Cash Flow Statement, Profit and Loss (Income) Statement, Balance Sheet/Financial Position Statement, Statement of Retained Earnings), Security and Exchange Commission (SEC) Reporting Statements (e.g., 10-K, 10-Q, etc.), IRS Reporting, etc. Financial ratios that can be calculated from raw information in such financial statement(s) can also be included as attributes 220 in the tables.

In various embodiments, the financial data can include, but not be limited to, for example, Total Asset Value, Total Liquid Assets, Cash, Total Liabilities, Long Term Debt Amount, Short Term Debt Amount, Working Capital Ratio, Current Ratio, Quick Asset Ratio (Acid Test), Debt Ratio, Debt to Equity Ratio, Earnings-per-Share (EPS), Price-Earnings (P/E) Ratio, Cash Ratio, Asset Turnover Ratio, Earnings Before Interest, Taxes, Depreciation, and Amortization (EBITDA), Earnings before Interest and Taxes (EBIT), Total Profit, Accounts Receivable, Inventory, Days sales outstanding (DSO), Equity, Sales, Operating Revenue, Non-Operating Revenue, Operating Expenses, Fixed Costs, Cost of Goods Sold, Depreciation, Net Income, Retained Earnings, Gross Margin Ratio, and combinations thereof.

At block 650, in various embodiments, the predictions can be used to evaluate and terms for loan agreements, determine interest rates for bonds being issued, and/or calculate future stock prices to determine if purchases or sales of stock should be made.

In various embodiments, the decision tree can increase the likelihood that the banker, trader, or other investor will have stock orders, financial contract, and bond issues filled at desirable prices and quantities. Business failure probability is displayed to the user without the congestion of raw data and extraneous information for timely financial decisions.

In one or more embodiments, the algorithm will input multiple year financial reports tables and generate transition rules for a decision tree that can identify and predict good (viable)/bad (failing) companies from financial data of companies with currently unknown outcomes. The can help the user avoid poor financial decisions and the resulting financial losses that can come from poor financial decisions. This can provide increased return on investments and reduced monetary losses for an individual or financial institution (e.g., bank, lending house, investment firm, etc.).

In various embodiments, the prediction(s) from the decision tree can be used by a user to make real-time decisions about lending money to, investing in, or establishing loan terms for the company with the unknown outcome.

In various embodiments, the prediction (classifying leaf node) for the business entity can be displayed to the used on a screen (e.g., computer screen, tablet, smart phone, etc.) to inform the user and/or representative of the business entity about the final financial decision.

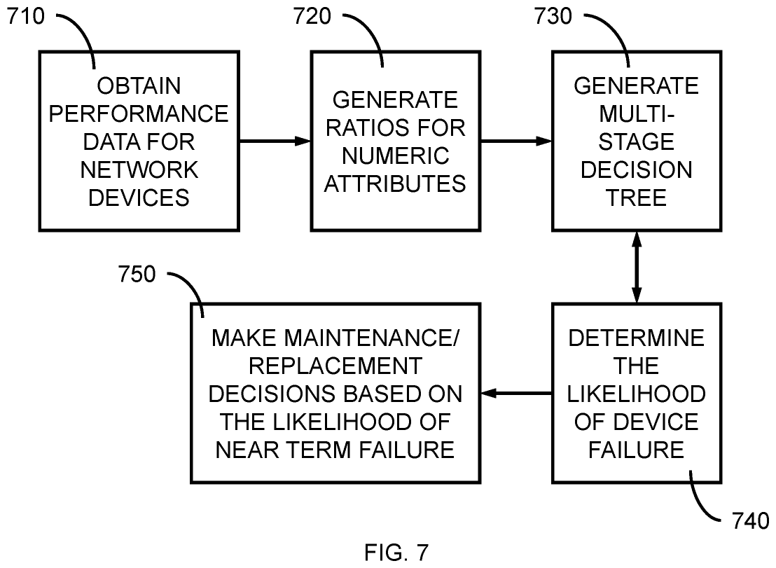

FIG. 7 is a block/flow diagram illustrating a non-limiting exemplary embodiment for a method of determining the probability for a communication or network device failing, in accordance with an embodiment of the present invention.

At block 710, a set of maintenance records for a plurality of electronic devices (e.g., routers, servers, gateways, switches, repeaters, wireless hubs, etc.) forming a network can be obtained. The maintenance records can be for a predetermined interval of time, for example monthly, quarterly, or yearly reports, and include dates for replacement and/or upgrade of device that failed over the recorded time period. The maintenance and replacement records can be relevant for making replacement and upgrade decisions at a particular time, and provide sufficient data to evaluate each of the plurality of electronic networking/communication devices forming the communication network. The performance data can include knowledge of whether the electronic devices are still in existence and functioning in the network or have failed at some previous time. A number of attributes that can effectively classify each of the electronic devices can be selected from the available performance data to produce a set of data tables having a row, R, and column, C, matrix format, R×C.

Each of the entities 210 can be characterized by a set of one or more attributes 220 having known values. A data set in the form of data tables 201, 202, 205 can be a matrix of entities and attribute values, (which can be referred to as a matrix of instances and attributes). A null value can be used for attributes not known or possessed by an entity or instance. The attributes may be numerical (i.e., a numeric value) or categorical (i.e., a class type selected from a specified set (also referred to as nominal or enumerated)). Numeric values may be real numbers, integers, ratios, etc., for example, bandwidth, number of processors, processor speed, amount of memory, device age, number of communication ports, etc. Class types may identify a non-numeric characteristic, for example, device type (e.g., server, router, switch, etc.), device brand, device model, on/off, liquid cooled, air cooled, supported protocols, including, but not limited to, transport layer protocols (e.g., TCP/IP, UDP, etc.), session layer protocols (e.g., RPC/RTCP, SDP, etc.), presentation layer protocols (e.g., FTP, IMAP, etc.), application layer protocols (e.g., HTTP, SMTP, IRC, POP, etc.), ethernet (e.g., 10 GbE, etc.), etc. Data for class type attributes may have Boolean values of true or false. Attribute values may be ordered, for example, A>B>C.

In various embodiments, the available data can be preprocessed to be consistent between entities, examples, and/or time periods, so uniform data can be inputted to the model. Data for the same attributes can be preprocessed to have the same units (e.g., gigahertz, etc.) and/or range of values, which may involve conversion between units and/or normalization or standardization. Normalization and standardization may be used to convert wider ranges of numeric attribute values to a fixed range, for example, 0 to 1. Nominal (categorical) attribute quantities may be converted into numeric values through a distance function, where a value of 1 can indicate that the nominal values are different, and a value of 0 can indicate that the nominal values are the same, for example, server=server=0; wireless hub≠Nat translator=1. A null value can be used for attributes not known or possessed by an entity or instance.

At block 720, ratios can be calculated for numeric attributes over sequential time periods, for example, packet throughput/loss at time period n divided by packet throughput/loss at time period n−1. Separate tables can be constructed using the calculated ratios.

At block 730, a multi-stage decision tree can be generated for classifying the electronic devices using the data tables previously constructed. A decision tree algorithm can be used to construct a decision tree for a time period using the available data tables and/or constructed ratio tables.

In one or more embodiments, the model for the Decision Trees and multi-stage decision tree can be trained through supervised learning where examples with the actual outcomes identified by experts can be inputted into the model. The tables or matrixes including the attributes for the examples leading to the known results can be inputted into the model. Each instance that provides such input can be characterized by its values on a fixed, predefined set of features or attributes presented in a row of cells in the tables 201, 202, 205. In various embodiments, the decision tree may not be constructed starting with the first available time. Instead the decision tree construction may start with data from a later (e.g., second, third, etc.) time period for the first level decision tree.

In one or more embodiments, the model can be a decision tree having nodes and leaves. The leaves of the Decision Tree can identify the result or class that the entity or example 110 is identified with. In various embodiments, the Decision Tree can have two or more results or classes, for example, pass/fail, succeed/fail, positive/negative, high/middle/low, high/normal/low, top/middle/bottom, etc. The examples/entities can be sorted into one of the two or more results or classes using the Decision Tree.

In one or more embodiments, training the model can involve analyzing an initial set of examples or entities having known outcomes, also referred to as a training set. The model can be trained using supervised learning, where an expert analyzes the examples and generates tests for the model. The tests can be incorporated into nodes of a Decision Tree starting at a root node and progressing through intermediate nodes to leaf nodes that classify the example/entity. The nodes can have a branch for each possible outcome, where the branch appropriate to the test outcome can be taken to the next node or leaf. The example or entity can be assigned to a class identified by the particular leaf. Classification outcomes at the leaves may have a predetermined confidence level. If there are sufficient distinguishing attributes, it is possible to construct a decision tree that can correctly classifies each object in a training set.

In various embodiments, the accuracy of the model can be determined by a success rate on test cases for which the outcome/result is also known, but were not previously used for training. Success of the model may also be measured in terms of how acceptable the rules or decision tree is to a user. The accuracy of the model may be expressed as a purity factor that represents a threshold percent (e.g., 85%, 90%, 95%, 99%, etc.) of test cases determined accurately from a test set of cases.

In one or more embodiments, once the model of the Decision Tree is trained, other objects (e.g., entities) can be correctly classified by applying the attribute tests at the nodes of the Decision Tree. The Decision Tree can be applied to objects for which the outcome is not known.

At block 740, in one or more embodiments, the model learns to predict whether an electronic device is functioning or likely to fail as an outcome based on the maintenance records of the electronic devices. Identifying failure and success patterns from performance data in maintenance records can improve the allocation of limited funds amongst multiple network devices, and avoid device failure, network down time, and the loss of millions of dollars in revenue, as well as customer confidence. Determining whether further costs incurred for maintenance can prolong a device's life or are likely to be wasted can reduce costs and increase network performance.

The decision tree can learn to classify electronic devices in the network as viable or not viable for making replacement/upgrade decisions, for example, whether a server should be replaced with a more expensive model within the next quarter, or just expanded memory should be purchased and installed.

In a non-limiting exemplary embodiment, a network device's performance can be shown by the quality of service provided through lost packets and/or reduced throughput/speed (e.g., for the month, quarter, year, etc.) may indicate two possible conditions, one where the device is still functioning satisfactorily, and another where the failure probability for the coming time period becomes much greater. A user could predict the likelihood of the device failing based on the known attributes of the of the type of device. The next time period, new values for the device performance and maintenance may be provided showing any further change in the device's performance. The network device performance as shown by the new maintenance records and performance data can be used to determine whether the likelihood of the device failing has increased, so that the likelihood of failure is greater, or has remained the same, so the likelihood of failure in the coming time period is minimal. The analysis of the performance data for successive time periods can show the performance trajectory that the device is on, so a systems operator can determine whether to invest in the replacement device(s), and at what savings on reduced down time could be expected.

In a non-limiting exemplary embodiment, for each instance 210, there are feature records for n consecutive months, and one label 240 to characterize the outcome of that instance, as success or failure. “n” can be a hyper-parameter that defines the time steps for considering a transition pattern. A first table 201 can be a set of data for a first month for a set of entities 210 (e.g., network electronic devices), where the data may be available for each of the device's maintenance records (e.g., performance data). Packet loss ratios that can be calculated from raw information in such records can also be included as attributes 220 in the tables.

In various embodiments, the performance data can include, but not be limited to, for example, data throughput, bandwidth, Quality-of-Service (QoS), mean time between failure, latency, and combinations thereof.

In various embodiments, the decision tree can increase the likelihood that the electronic device(s) will be replaced at opportune times and reasonable cost. The device failure probability can be displayed to the user without the congestion of raw data and extraneous information for timely maintenance decisions.

In one or more embodiments, the algorithm will input multiple month performance tables and generate transition rules for a decision tree that can identify and predict good (viable)/bad (failing) devices from the performance data of devices with currently unknown outcomes. The predictions can help the user avoid poor technical and financial decisions and the resulting financial losses that can come from poor maintenance/replacement decisions. This can provide increased return on investments and reduced monetary losses for an individual, company (e.g., local area network (LAN) user, or communication business (e.g., fiber optic trunk provider, wide area network provider, internet service provider, etc.).

At block 750, in various embodiments, the prediction(s) from the decision tree can be used by a user to make real-time decisions about investing in or replacing network components for the company with devices having the unknown outcome.

In various embodiments, the prediction (classifying leaf node) for the electronic device(s) can be displayed to the used on a screen (e.g., computer screen, tablet, smart phone, etc.) to instruct the user about the final maintenance/replacement decision.

Algorithm 1: Multi-stage Decision Tree Construction

Input: a sequence of table values {T1, T2, ..., Tk} on attribute set {a1, a2, ...,

ap}, where each table has N instances {s1, s2, ..., sN} with each row as an instance, each
instance over k intervals (time stamps) is coupled with a label Lᵢ, 2<= i <= M, there are in
total M instances; maximum depth in each time layer, Dmax, is a hyper parameter that can
be set by user input to limit the number of node layers in a decision tree for each of the
stages (Levels) to avoid overfitting. Node Purity/Threshold purity is the ratio of correct
instances to total instances that arrive at a given leaf when the decision tree is tested using
instances not initially used to model/build the decision tree.

Output: Tree
Tree = { }
S = {s1, s2, ..., sN}; //sample set
for i=1:k
T_temp = Ti
If i != 1
Temp = Ti/Ti−1; //calculate ratio of consecutive two-time points tables
Temp = Ti/Ti−1; //calculate ratio of consecutive two-time points tables
T_temp = Ti U Temp; // concatenate table Temp and Ti, where “U” is union
Tree_i <== Using C4.5 or ID3 algorithm on table T-temp for instances in S to

construct the decision tree with maximum depth in each time layer Dmax, and Node Purity
threshold Pu;

S<==samples in leaf node of Tree_i that has purity < Pu;
Tree <== Tree U Tree_i;// concatenate trees in layer-wise
End
Return Tree

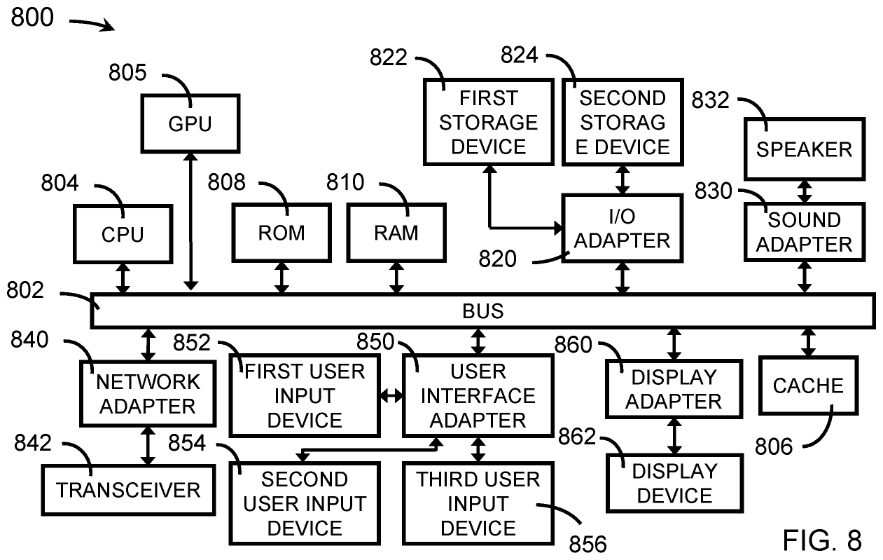

FIG. 8 is an exemplary processing system 800 to which the present methods and systems may be applied, in accordance with an embodiment of the present invention.

The processing system 800 can include at least one processor (CPU) 804 and may have a graphics processing (GPU) 805 that can perform vector calculations/manipulations operatively coupled to other components via a system bus 802. A cache 806, a Read Only Memory (ROM) 808, a Random Access Memory (RAM) 810, an input/output (I/O) adapter 820, a sound adapter 830, a network adapter 840, a user interface adapter 850, and a display adapter 860, can be operatively coupled to the system bus 802.

A first storage device 822 and a second storage device 824 are operatively coupled to system bus 802 by the I/O adapter 820. The storage devices 822 and 824 can be any of a disk storage device (e.g., a magnetic or optical disk storage device), a solid state magnetic device, and so forth. The storage devices 822 and 824 can be the same type of storage device or different types of storage devices.

A speaker 832 is operatively coupled to system bus 802 by the sound adapter 830. A transceiver 842 is operatively coupled to system bus 802 by network adapter 840. A display device 862 is operatively coupled to system bus 802 by display adapter 860.

A first user input device 852, a second user input device 854, and a third user input device 856 are operatively coupled to system bus 802 by user interface adapter 850. The user input devices 852, 854, and 856 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 852, 854, and 856 can be the same type of user input device or different types of user input devices. The user input devices 852, 854, and 856 can be used to input and output information to and from system 800.

In various embodiments, the processing system 800 may also include other elements (not shown), as readily contemplated by one of skill in the art, as well as omit certain elements. For example, various other input devices and/or output devices can be included in processing system 800, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 800 are readily contemplated by one of ordinary skill in the art given the teachings of the present principles provided herein.

Moreover, it is to be appreciated that system 800 is a system for implementing respective embodiments of the present methods/systems. Part or all of processing system 800 may be implemented in one or more of the elements of FIGS. 1-7. Further, it is to be appreciated that processing system 800 may perform at least part of the methods described herein including, for example, at least part of the method of FIGS. 1-7.

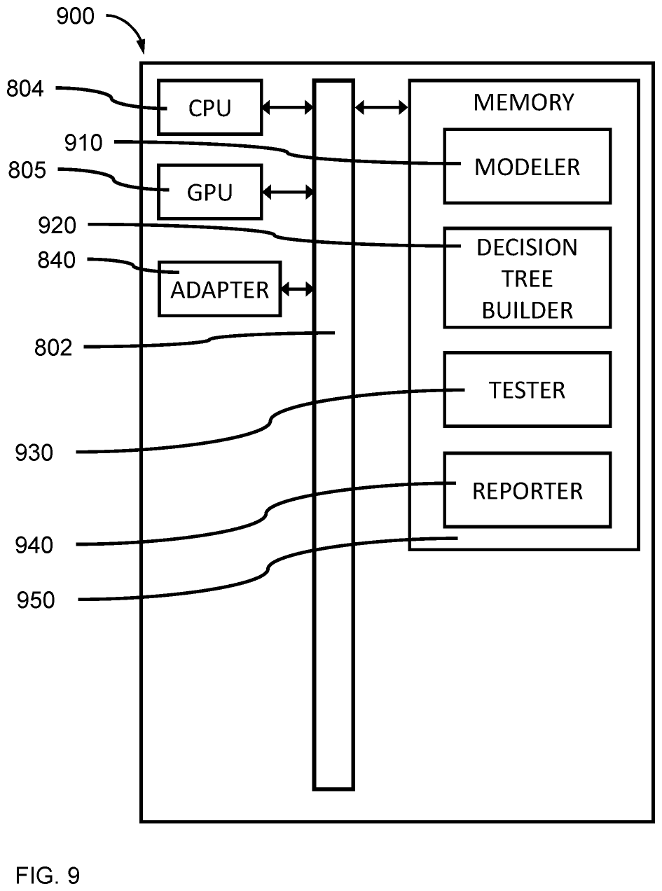

FIG. 9 is an exemplary processing system 900 configured to implement a multi-stage decision tree, in accordance with an embodiment of the present invention.

In one or more embodiments, the processing system 900 can be a computer system 800 configured to perform a computer implemented method of identifying viable business entities.

In one or more embodiments, the processing system 900 can be a computer system 900 having memory components 950, including, but not limited to, the computer system's random access memory (RAM) 810, hard drives 822, and/or cloud storage to store and implement a computer implemented method of building and implementing multi-stage decision trees that can identify viable business entities. The memory components 950 can also utilize a database for organizing the memory storage.

In various embodiments, the memory components 950 can include a modeler 910 that can be configured to implement a modeling algorithm, that can identify attribute based tests for decision nodes of a decision tree, from financial or maintenance data obtained from a computer system and/or network. The modeler 910 can also be configured to receive as input business records or device records formatted as tables populated by data including financial or maintenance data. The business or maintenance record data can have nominal or numeric values.

In various embodiments, the memory components 950 can include a decision tree builder 920 configured to build a multi-stage decision tree using the modeling algorithm, where the attribute based tests can form the nodes and leaves of the decision tree. The identified test with the greatest information gain can be implemented as the root node of the tree, and each lower layer of the decision tree can include a node for an attribute test that provides the next greatest information gain. The decision tree builder 820 can also be configured to form a multi-stage decision tree using attribute tests developed from data for different time periods, where the time periods can be sequential.

In various embodiments, the memory components 950 can include a tester 930 configured to receive as input a business record having values for one or more attributes but lacking a value for the label, such that the outcome for the associated business entity or communication/electronic device is unknown. The tester can be configured to input business record(s) for the business entity or maintenance records for communication devices into the decision tree to determine the label value and predict the outcome of the entity.

In various embodiments, the memory components 950 can include a reporter 940 configured to report a predicted outcome for the business entity to a user to determine the amount of financial investment to make in the business entity, or for a communication device to make repair/replacement decisions. The reporter can output the predicted outcome to a display screen for viewing and implementation by the user.

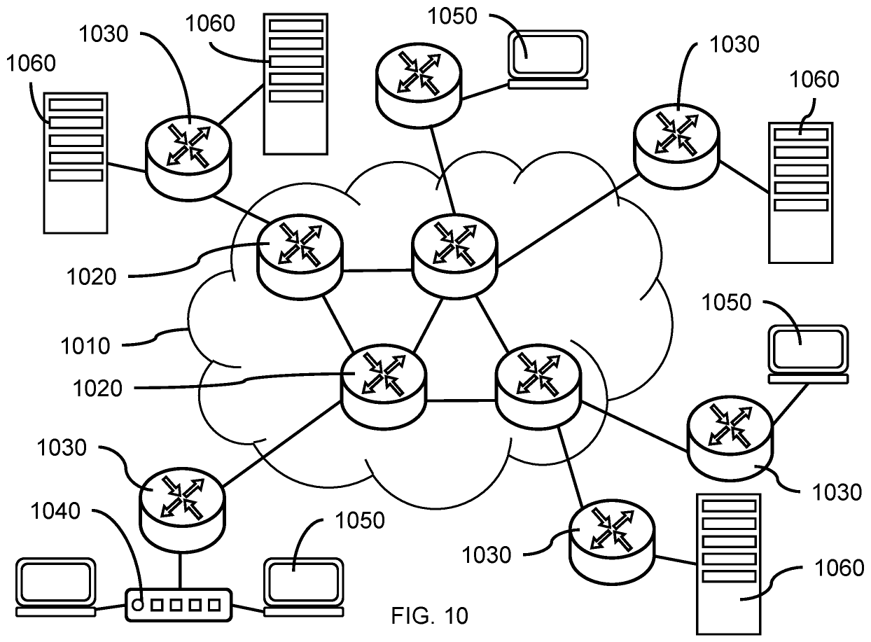

FIG. 10 is a diagram of a network including electronic communication devices, in accordance with an embodiment of the present invention.

A core network 1010 can include multiple interconnected switches 1020 that route packets across the network. The core network 1010 can interconnect multiple local networks (e.g., local area networks (LANs)) along the edge using edge switches and routers 1030. The core layer is the backbone of the network and can include high-end switches and high-speed cables. A core switch 1020 can have the ability to pass traffic across the core without 1 Gbps or even 10 Gbps limits.

A switch 1020 can filter and forwards packets between LAN segments. Network switches connect devices like computers 1050, printers, and servers 1060 on the same network, and enable the connected devices to share information and talk to each other. A switch 1020, 1030 can maintain a table of MAC addresses (MAC Address table or CAM Table) and what physical switch port they are connected to. Switching can move data packets (e.g., Ethernet Frames) within the same network. A network switch is a computer networking device which connects various devices together on a single computer network. It may also be used to route information in the form of electronic data sent over networks. Since the process of linking network segments is also called bridging, switches can be referred to as bridging devices. A switch can decide which computer a message is intended for and send the message directly to that computer.

The switches 1030 connecting directly to the end user devices are called “edge” or “access” switches. Access switches 1030 can have the highest port density, but may provide the lowest throughput-per-port of all network switch types. Layer 2 switches can forward Ethernet frames between Ethernet devices. Layer 2 switches would not involve IP addresses, nor would they examine IP addresses, as the frames flow through the switch. Instead, they would forward frames based on the media access control (MAC) address.

An edge switch 1030 can be a router, which can offer network address translation (NAT), NetFlow, and quality of service (QoS) Services, while a switch may not provide such services.

Routing routes packets between different networks. A router knows where to send a packet by using the Network segment of a destination IP address. A router can maintain a table called Routing Table, and uses the routing table to determine the route to the destination network.

A hub 1040 can act as a common connection point for other devices communicating over the same network. User devices 1050, for example, desk top computers, lap top computers, tablets, printers, etc., can be connected to the edge switches or routers 1030 through a hub 1040.

Network service providers and content providers can have multiple servers 1060 connected to the core network 1010 and accessible to user devices 1050 through the edge routers 1030 and their own hubs and switches.

In various embodiments, the maintenance records, including performance data and attributes, can be collected for each of the devices from available sources and used to produce data tables 201, 202, 205 for each of the devices for predetermined time periods. The data tables 201, 202, 205, can included a plurality of instances 210 that can have the one or more attributes 220 and known outcomes, for example, operational versus failed. A decision tree 400 can be generated using the attributes and data using a decision tree algorithm.

In various embodiments, failure of one or more of the electronic communication devices 1020, 1030, 1040, 1060 with unknown outcomes can be predicted using the decision tree operating on the performance data available for the electronic communication devices. Instructions can be provided to a user, for example, a system administrator, to replace or upgrade an electronic communication devices 1020, 1030, 1040, 1060 identified as likely to fail within the next data collection period, and the device replaced before incurring failure, loss of service, and downtime.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer implemented method for predicting device failure, comprising:
inputting a plurality of records for electronic communication devices, each including one or more attributes and a label, as a table to a modeling algorithm, wherein there are separate tables for each period in a time sequence;
building a multi-stage decision tree from the time sequence of records using the modeling algorithm running on a processor device;
inputting a record for a device having an empty label value into the decision tree to determine the likelihood of entity failure; and
reporting a predicted failure for the device to a user on a display to initiate replacement before a next time period.

2. The computer implemented method, as recited in claim 1, wherein the records include performance data for the electronic communication devices that populates the cells of the tables for the one or more attributes.

3. The computer implemented method, as recited in claim 2, wherein the label value identifies failure of each of the plurality of electronic communication devices over the time sequence as a boolean operator.

4. The computer implemented method, as recited in claim 3, wherein each separate stage of the multi-stage decision tree is built from the records of a different period in the time sequence.

5. The computer implemented method, as recited in claim 4, wherein the one or more attributes in the table includes at least one numeric value.

6. The computer implemented method, as recited in claim 5, further comprising, building a ratio table using at least one of the attributes for the performance data having a numeric value in a table for a second time period divided by the same attribute for the performance data having a numeric value in a table for a first time period.

7. The computer implemented method, as recited in claim 6, wherein the at least one attribute used for the ratio table includes data throughput.

8. A non-transitory computer readable storage medium comprising a computer readable program for identifying viable business entities, wherein the computer readable program when executed on a computer causes the computer to perform the steps of:
inputting a plurality of records for electronic communication devices, each including one or more attributes and a label, as a table to a modeling algorithm, wherein there are separate tables for each period in a time sequence;
building a multi-stage decision tree from the time sequence of records using the modeling algorithm running on a processor device;
inputting a record for a device having an empty label value into the decision tree to determine the likelihood of entity failure; and
reporting a predicted failure for the device to a user on a display to initiate replacement before a next time period.

9. The computer readable program as recited in claim 8, wherein the records include performance data for the electronic communication devices that populates the cells of the tables for the one or more attributes.

10. The computer readable program as recited in claim 9, wherein the label value identifies failure of each of the plurality of electronic communication devices over the time sequence as a boolean operator.

11. The computer readable program as recited in claim 10, wherein each separate stage of the multi-stage decision tree is built from the records of a different period in the time sequence.

12. The computer readable program as recited in claim 11, wherein the one or more attributes in the table includes at least one numeric value.

13. The computer readable program as recited in claim 12, further comprising, building a ratio table using at least one of the attributes for the performance data having a numeric value in a table for a second time period divided by the same attribute for the performance data having a numeric value in a table for a first time period.

14. The computer readable program as recited in claim 13, wherein the at least one attribute used for the ratio table includes data throughput.

15. As system for identifying viable business entities, comprising:
at least one processor device;
computer memory;
a modeler configured to receive, as input to a modeling algorithm, a plurality of records for electronic communication devices, each including one or more attributes and a label, as a table to a modeling algorithm, wherein there are separate tables for each period in a time sequence;
a decision tree builder configured to build a multi-stage decision tree from the time sequence of records using the modeling algorithm running on the at least one processor device;
a tester configured to receive as input a record for a device having an empty label value into the decision tree to determine the likelihood of entity failure; and
a reporter configured to report a predicted failure for the device to a user on a display to initiate replacement before a next time period.

16. The system as recited in claim 15, wherein the records include performance data for the electronic communication devices that populates the cells of the tables for the one or more attributes.

17. The system as recited in claim 16, wherein the label value identifies failure of each of the plurality of electronic communication devices over the time sequence as a boolean operator.

18. The system as recited in claim 17, wherein each separate stage of the multi-stage decision tree is built from the records of a different period in the time sequence.

19. The system as recited in claim 18, wherein the one or more attributes in the table includes at least one numeric value.

20. The system as recited in claim 19, further comprising, building a ratio table using at least one of the attributes for the performance data having a numeric value in a table for a second time period divided by the same attribute for the performance data having a numeric value in a table for a first time period.
